(19) United States
(12) Patent Application Publication
(10) Pub. No.: US 2012/0237424 A1
(43) Pub. Date: Sep. 20, 2012

(54) METHOD FOR IN-SITU DOPING OF TITANIUM DIOXIDE FILM

(76) Inventor: Zuruzi Bin Abu Samah, Singapore (SG)

(21) Appl. No.: 13/512,186

(22) PCT Filed: Dec. 7, 2009
(86) PCT No.: PCT/SG2009/000471

§ 371 Date: May 25, 2012

(51) Int. Cl. C01G 23/047; C01G 23/08

(52) U.S. Cl. 423/275

(57) ABSTRACT

A method of producing a titanium dioxide film with dopant uniformly dispersed throughout the entirety of the film The method involves deposition of dopant, concurrently or sequentially, with titanium before oxidation of the titanium. No separate doping step is required in this invention since the doping step occurs in-situ during oxidation process. The amount of dopant incorporated into a titanium dioxide film is controllable by varying the thickness and/or number of dopant layers deposited. Furthermore, dispersion of dopant throughout the titanium dioxide film is more uniform in this invention as multiple layers of dopant may be employed.

### FIELD OF THE INVENTION

This invention relates to titanium dioxide. More particularly, this invention relates to a titanium dioxide film dispersed with a dopant and a method of preparing the film. Still more particularly, the method of preparing a doped titanium dioxide film in accordance with this invention involves deposition of a desired dopant, concurrently or sequentially, with titanium before oxidation of the titanium; and formation of a titanium dioxide gel layer with dopant incorporated within the layer.

### BACKGROUND OF THE INVENTION

Titanium dioxide, also known as titania, has a wide range of uses including a pigment for paint, a food colouring, a sunscreen, a photocatalyst, etc. One method of forming a titanium dioxide film is depositing a layer of titanium on a substrate followed by oxidation in a liquid oxidizing agent, such as aqueous hydrogen peroxide. During oxidation process, the titanium layer is oxidised to form an amorphous gel, called a titanium dioxide gel layer. FIG. 1 illustrates a diagram of a prior art method to deposit a layer of titanium 101 on a substrate 103 in a sputtering chamber 100. The layer of titanium can be obtained by various deposition techniques, such as physical vapour deposition, chemical vapour deposition, etc.

In some applications, a doping agent (or dopant/additive) is added into a titanium dioxide film to modify the film properties, such as electrical conductivity, optical properties, chemical stability, thermal stability, etc. For example, carbon is added into titanium dioxide as a dopant to enhance the photocatalytic property of titanium dioxide. In this context, the type of dopant used and the distribution profile of the dopant in the titanium dioxide film are important as both affect the properties of the film. It is a known problem to obtain a titanium dioxide film with dopants uniformly dispersed throughout the entirety of the film. Typically, prior art methods only allow a dopant to disperse into a small area proximate a contact surface of the film during a doping process. This is because prior art methods immerse the titanium dioxide gel layer in a medium containing the dopant. This conventional doping method is illustrated in FIG. 2. For example, to dope tin (Sn) into titanium dioxide, the titanium dioxide gel layer 201 is immersed in a dopant solution containing tin ions 203, such as aqueous tin chorine. The dopant ions diffuse into the titanium dioxide gel layer with a higher concentration of dopant proximate the contact surface 205. After the immersion, the gel layer is annealed at an elevated temperature to transform the titanium dioxide gel layer doped with a desired dopant 301 into a crystalline state. As illustrated in FIG. 3, this type of doping method creates a gradient concentration of dopant within the titanium dioxide film 301, i.e. the contact surface having a higher concentration of dopant than other areas of the film.

The aforementioned doping method has other disadvantages. One disadvantage is that all ionic species present in the doping solution are incorporated fully into the titanium dioxide gel layer. The incorporation of some undesirable species may degrade the properties of the titanium dioxide film. Another disadvantage is that the amount of dopant being incorporated into the titanium dioxide is difficult to control as the concentration of the dopant in the solution proximate the contact surface of the titanium dioxide gel layer is reduced over time. Thus, less of the dopant in the solution is diffused into the gel layer over time. Therefore, those skilled in the art are constantly striving to find a better way to add dopant into a titanium dioxide film.

### SUMMARY OF THE INVENTION

The above and other problems are solved and an advance in the art is made by the method in accordance with this invention. A first advantage of a method in accordance with this invention is that incorporation of dopants into a titanium dioxide film (“doping step”) occurs during oxidation of the film (“oxidation step”). Therefore, unlike conventional methods, the doping and oxidation of the titanium in accordance with this invention occur concurrently (in-situ) in a single step. No separate doping step (e.g. immersing the film in a dopant solution) is required in this invention. Hence, the doping method of this invention is simpler than conventional methods. A second advantage of a method in accordance with this invention is that incorporation of a desired dopant into a titanium dioxide film by way of deposition avoids incorporation of undesired anions from the dopant solution. A third advantage of a method in accordance with this invention is that the amount of dopant incorporated into a titanium dioxide film is controllable by varying the thickness and/or number of dopant layers deposited. For example, a thicker layer of dopant or more layers of dopant may be employed if a higher concentration of dopant is desired. A fourth advantage of a method in accordance with this invention is that dispersion of dopant throughout the titanium dioxide film is more uniform as multiple layers of dopant may be employed in this invention.

The present invention provides a method for producing a titanium dioxide film which contains an additive of at least one doping agent (or dopant) uniformly dispersed throughout the entirety of the film. The dopant is selected from a group including platinum, palladium, silver, tin, aluminium, copper and other dopants that are amenable to thin film deposition. The dopant can be deposited by different techniques, either concurrently or sequentially with the titanium. A common deposition technique is sputtering, such as physical vapour deposition or chemical vapour deposition, etc.

In accordance with one embodiment of this invention, a layer of dopant is deposited and embedded between two layers of titanium by a sequential deposition process. The number of layers of titanium and dopant to be deposited depends on the desired property of the titanium dioxide film to be achieved. This deposition method creates a structure with layers of titanium interleaved with layers of dopant. This multiple-layered structure of titanium and dopant then undergoes an oxidation process whereby the structure is immersed in an oxidising agent. During oxidation, titanium is oxidised to form a gel layer, called titanium dioxide gel, with dopant incorporated within the layer. The titanium dioxide gel layer is then annealed at an elevated temperature to transform the titanium dioxide gel layer into a crystalline state with dopant uniformly dispersed throughout the entirety of the film.

In accordance with a second embodiment of this invention, dopant is deposited together with titanium on a substrate in a single deposition process, such as co-sputtering. This concurrent deposition method produces a layer of titanium intermixed with dopant. The layer is then undergoes an oxidation process, similar to the first embodiment as discussed above, to form a titanium dioxide gel layer with dopant incorporated within the layer. This is followed by an annealing process at an elevated temperature to transform the titanium dioxide gel layer into a titanium dioxide film with dopant uniformly dispersed throughout the entirety of the film.

Unlike conventional methods, deposition of dopant in accordance with this invention occurs before oxidation of titanium. Foremost, the dopant is more uniformly incorporated into the titanium dioxide gel layer during oxidation process, and thus the additional doping step is eliminated in this invention. The titanium dioxide film produced in accordance with this invention having a more uniform dispersion of dopant throughout the entirety of the film, and thus significantly overcomes the disadvantages as discussed in the previous section.

### BRIEF DESCRIPTION OF DRAWINGS

The above and other features and advantages of a doped titanium dioxide film in accordance with this invention are described in the following detailed description and are shown in the following drawings:

FIG. 1 illustrating a diagram of a prior art method to deposit a layer of titanium on a substrate;

FIG. 2 illustrating a diagram of a prior art method to dope a titanium dioxide gel layer;

FIG. 3 illustrating a diagram of a gradient concentration of dopants in a titanium dioxide film of a prior art method;

FIG. 4 illustrating deposited layers of titanium and dopant in accordance with one embodiment of this invention;

FIG. 5 illustrating a titanium film incorporated with dopant in accordance with one embodiment of this invention being oxidised;

FIG. 6 illustrating a titanium dioxide film with dopant uniformly dispersed throughout the entirety of the film in accordance with one embodiment of this invention;

FIG. 7 illustrating a flow diagram of a method for producing a titanium dioxide film with dopant uniformly dispersed throughout the entirety of the film in accordance with one embodiment of this invention; and

FIG. 8 illustrating a flow diagram of a method for producing a titanium dioxide film with dopant uniformly dispersed throughout the entirety of the film in accordance with another embodiment of this invention.

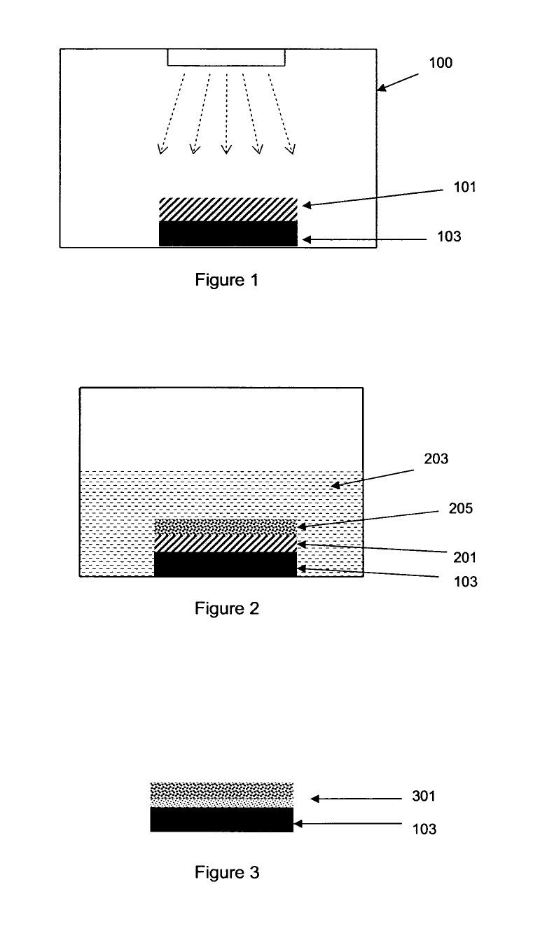

### DETAILED DESCRIPTION OF INVENTION

This invention relates to titanium dioxide. More particularly, this invention relates to a titanium dioxide film incorporated with a dopant and a method of preparing the film. Still more particularly, the method of preparing a doped titanium dioxide film in accordance with this invention involves deposition of the desired dopant, concurrently or sequentially, with titanium before oxidation of the titanium; and formation of a titanium dioxide gel layer with dopant incorporated within the layer. One skilled in the art will recognize that although the method is described for adding a dopant to titanium dioxide, the method may be used with other compounds without departing from this invention. For clarity same components shown in more than one figure are given the same reference numeral throughout this description.

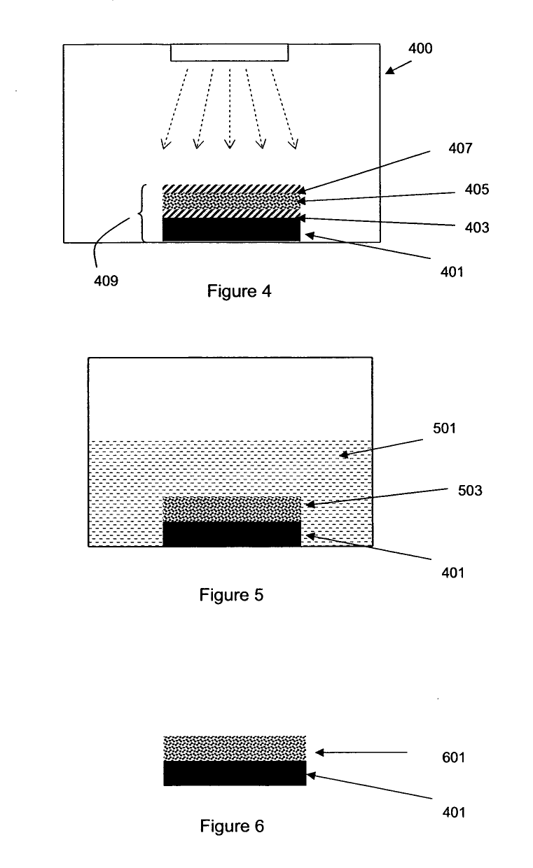

FIGS. 4-5 illustrate a method of producing a titanium dioxide film with dopant uniformly dispersed throughout the entirety of the film in accordance with one embodiment of this invention. A substrate 401, for example made of silicon, is placed in a cavity 400 as illustrated in FIG. 1. The cavity 400 can be any deposition system such as a physical vapour deposition sputtering chamber. The exact deposition technique is not important to this invention and is left as a design choice to those skilled in the art. A first layer of titanium 403 is deposited on the substrate 401. A layer of dopant 405 is then deposited on the first layer of titanium 403. A second layer of titanium 407 is deposited on the dopant layer 405. This sequential deposition process creates a structure 409 with a layer of dopant 405 embedded between two layers of titanium 403, 407. One skilled in the art will recognize that a structure with multiple layers of titanium interleaved with layers of dopant can be obtained with the deposition process as described above. The exact number of layers of titanium and dopant and the order of the layers of titanium and dopant are left as a design choice to those skilled in the art. One way of controlling the desired amount of dopant present in the titanium dioxide film is by varying the thickness and/or number of the dopant layers. For example, a higher concentration of dopant can be achieved by depositing a thicker dopant layer and/or more dopant layers, and vice versa.

FIG. 5 illustrates an oxidation process of the multiple-layered structure 409. The multiple-layered structure 409 is immersed in a liquid oxidation agent 501 (oxidant). A typical oxidant is hydrogen peroxide although any other suitable oxidant may be used. During an oxidation process, titanium interacts with the oxidizing agent and forms a titanium dioxide gel layer 503. The dopant 405 which has been intimately embedded between the titanium layers 403, 407 is uniformly incorporated into the titanium dioxide gel layer 503 during the oxidation process. This step is important as oxidation of titanium to form titanium dioxide gel layer and incorporation of dopant into the titanium dioxide gel layer take place simultaneously or in-situ during a single step of oxidation.

The titanium dioxide gel layer with dopant uniformly incorporated within the layer then undergoes an annealing process. The annealing process is performed at an elevated temperature from about 300° C. to 700° C. and may be carried out in air or an inert environment. The annealing process enhances the dispersion of dopant within the titanium dioxide film 601 as illustrated in FIG. 6. Therefore, the titanium dioxide film obtained in accordance with one embodiment of this invention has dopant more uniformly dispersed throughout the entirety of the film, in comparison to conventional methods. One way of improving the uniformity of the dopant within the film is to have more layers of dopant interleaved with layers of titanium during deposition step.

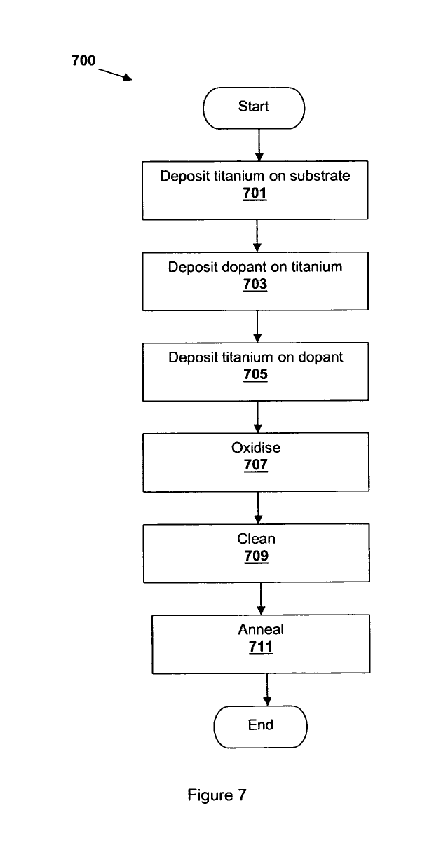

The processes discussed in FIGS. 4-5 in accordance with one embodiment of the invention is now described in a flow diagram in FIG. 7. FIG. 7 illustrates a flow diagram of process 700 for producing a titanium dioxide film with dopant uniformly dispersed throughout the film. The process begins in step 701 by depositing a first layer of titanium on a substrate. A layer of dopant is deposited on the first layer of titanium in step 703. A second layer of titanium is deposited on the layer of dopant in step 705. An oxidation process occurs in step 707 whereby the multiple-layered structure of titanium and dopant is immersed in a liquid oxidizing agent. The titanium dioxide gel layer is formed in step 707 during the oxidation process. The titanium dioxide gel layer is cleaned with de-ionized water in step 709 to remove unwanted residues. The cleaned titanium dioxide gel layer is then annealed at an elevated temperature in the range between 300° C. to 700° C. in step 711 and a doped titanium dioxide film is obtained. The annealing step creates a uniform concentration gradient of dopant throughout the titanium dioxide film.

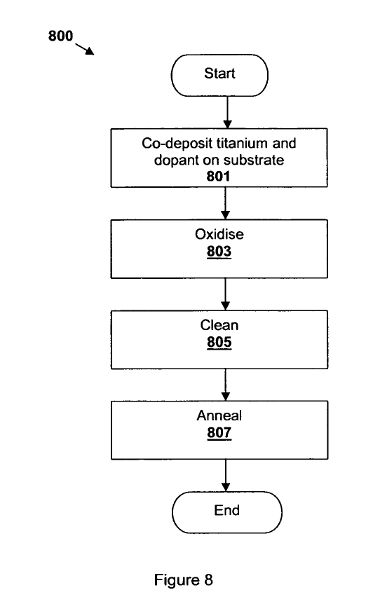

FIG. 8 illustrates a flow diagram of process 800 in accordance with another embodiment of this invention. As illustrated in FIG. 7, a structure with multiple layers of titanium and dopant is obtained by a sequential deposition process in steps of 701, 703 and 705. Alternatively, a layer of titanium intermixed with dopant can be obtained by a single deposition step in process 800. In general, the second embodiment of this invention is similar to the first embodiment as illustrated in FIGS. 4-6, except the deposition step. The process 800 begins by concurrently depositing a layer of titanium and dopant on a substrate. The layer of titanium intermixed with dopant is oxidized in step 803 to form a titanium dioxide gel layer. Since the dopant has been intermixed with the titanium during deposition step 801, the dopant is uniformly incorporated into the titanium dioxide gel layer during the oxidation step 803. The titanium dioxide gel layer is then cleaned with de-ionized water in step 805 to remove unwanted residues. The titanium dioxide gel layer is annealed at an elevated temperature in the range between 300° C. to 700° C. in step 807 and a doped titanium dioxide film is obtained.

The above embodiments provide a description of features and advantages of this invention. It is envisioned those skilled in the art can and will design alternative method that infringe on this invention as set forth in the following claims.

1. A method of preparing a doped titanium dioxide film comprising the steps of:
depositing a titanium and a dopant on a substrate to form a layer of said titanium intermixed with said dopant;
oxidising said layer of said titanium intermixed with said dopant in an oxidant to form a titanium dioxide gel having said dopant dispersed throughout said titanium dioxide gel; and
annealing said titanium dioxide gel to form said doped titanium dioxide film;

2. The method of claim 1 wherein said depositing step is a sequential deposition of said titanium and said dopant to form a plurality of layers of said titanium interleaved with a plurality of layers of said dopant.

3. The method of claim 2 wherein the concentration of said dopant dispersed throughout said titanium dioxide gel is controllable by varying the thickness of said plurality of layers of said dopant.

4. The method of claim 2 wherein the concentration of said dopant dispersed throughout said titanium dioxide gel is controllable by varying the number of said plurality of layers of said dopant.

5. The method of claim 1 wherein said depositing step comprises:
depositing a first layer of titanium on said substrate;
depositing a layer of dopant on said first layer of titanium; and
depositing a second layer of titanium on said layer of dopant.

6. The method of claim 1 wherein said depositing step comprises:
depositing a first layer of dopant on said substrate;
depositing a layer of titanium on said first layer of dopant; and
depositing a second layer of dopant on said layer of titanium.

7. The method of claim 1 wherein the concentration of said dopant dispersed throughout said titanium dioxide gel is controllable by varying the amount of said dopant during said depositing step.

8. The method of claim 1 wherein said depositing step is a sputtering process.

9. The method of claim 1 wherein said oxidising step creates a uniform dispersion of said dopant throughout said titanium dioxide gel.

10. The method of claim 1 wherein said annealing step creates a uniform concentration gradient of said dopant throughout said titanium dioxide film.

11. The method of claim 1 wherein said dopant is amenable to thin film deposition.

12. The method of claim 11 wherein said dopant is selected from a group consisting of platinum, palladium, silver, tin, aluminium, and copper.

13. The method of claim 1 wherein said oxidant is hydrogen peroxide.

14. The method of claim 1 wherein said annealing is at a temperature between about 300° C. to about 700° C.

15. A titanium dioxide gel comprising:
a layer of titanium dioxide; and
a dopant dispersed throughout said layer of titanium dioxide.

16. The titanium dioxide gel of claim 15 wherein said dopant is uniformally dispersed throughout said layer of titanium dioxide.

17. The titanium dioxide gel of claim 15 wherein said dopant has a uniform concentration gradient throughout said layer of titanium dioxide.

18. The titanium dioxide gel of claim 15 wherein said dopant is amenable to thin film deposition.

19. The titanium dioxide gel of claim 18 wherein said dopant is a material selected from a group consisting of platinum, palladium, silver, tin, aluminium, and copper

20. The titanium dioxide gel of claim 15 wherein said oxidant is hydrogen peroxide.
